(19) United States
(12) Patent Application Publication
(10) Pub. No.: US 2026/0258557 A1
(43) Pub. Date: Sep. 3, 2026

(54) LASER CLADDING APPARATUS HAVING ADJUSTABLE DUTY RATIO

(71) Applicant: SOOCHOW UNIVERSITY, Suzhou, Jiangsu (CN)

(72) Inventors: Jiaqiang LI, Suzhou, Jiangsu (CN); Lei JIN, Suzhou, Jiangsu (CN); Gangxian ZHU, Suzhou, Jiangsu (CN); Shihong SHI, Suzhou, Jiangsu (CN)

(21) Appl. No.: 18/717,123

(22) PCT Filed: Jun. 2, 2022
(86) PCT No.: PCT/CN2022/096853

§ 371 Date: Jun. 6, 2024

(30) Foreign Application Priority Data
Mar. 1, 2022 (CN) 202210198278.9

(51) Int. Cl. C23C 24/10

(52) U.S. Cl. CPC C23C 24/103

(57) ABSTRACT

Provided is a laser cladding apparatus having an adjustable duty ratio that comprises a reflector holder, a parabolic focusing reflector, a fixed conical reflector, a movable conical reflector and a powder nozzle. Reflecting surfaces of the movable conical reflector and the fixed conical reflector are arranged opposite to a reflecting focusing surface of the parabolic focusing reflector so as to reflect, in a circumferential direction, an incident beam to the reflecting focusing surface to be reflected and focused; the reflector holder comprises a first annular fixing part, a second annular fixing part; the fixed conical reflector is fixed on the second annular fixing part; the reflector holder further comprises a motion adjusting part configured to drive the movable conical reflector to move in the central axis direction of the parabolic focusing reflector, the movable conical reflector is fixed to the top end of the motion adjusting part.

### CROSS-REFERENCE TO RELATED APPLICATION

This application is a national stage application of International Patent Application No. PCT/CN2022/096853, filed on Jun. 2, 2022, which claims the benefit of and priority to Chinese Patent Application No. 202210198278.9, filed on Mar. 1, 2022, each of which is hereby incorporated by references herein in its entirety.

### TECHNICAL FIELD

The present disclosure relates to the field of laser additive manufacturing, in particular to a laser cladding apparatus having an adjustable duty ratio.

### BACKGROUND

Laser cladding forming technology, as an advanced surface coating preparation and additive manufacturing technology, has obtained the rapid development in recent years.

In this technology, a high-energy laser beam is used as a processing heat source to form a small molten pool on the surface of a metal substrate, and to rapidly melt materials fed into the molten pool. The melt can be rapidly solidified through the rapid movement and scanning of the heat source, so as to prepare a cladding layer which is in metallurgical bonding with the substrate or a three-dimensional part with performance equivalent to that of a forged component.

At present, the laser cladding forming technology can be divided into two types, e.g., outside-laser powder feeding (paraxial powder feeding), and inside-laser powder feeding (coaxial powder feeding), according to the position relationship between the laser and powder. In the inside-laser coaxial powder feeding, the annular laser beam is used as the heating source, and the laser energy is distributed in an M shape, which is beneficial to the uniform distribution of the temperature field in the molten pool. Meanwhile, by adopting a mode of a single powder tube type inside-laser powder feeding, the coaxial coupling effect of the laser and powder can be significantly improved, so as to achieve high-precision and high-quality forming. Besides the influence of laser process parameters (laser power, scanning speed, powder feeding speed, defocusing amount, etc.) on the forming structure and properties of metal materials, the duty ratio of the annular laser beam has a more significant impact on the forming structure and properties of metal materials due to its decisive role in energy distribution. Under different laser duty ratios, the formed structures have different characteristics, and significantly different mechanical and corrosion properties. The duty ratio is a ratio of the non-beam area inside the annular spot to the overall area of the spot. As can be known from a large number of experiments, there is excessive concentration of energy distribution when the duty ratio is between 0.5 and 1, resulting in defects such as poor stability in the forming process and insufficient performance of the formed parts. Therefore, this present disclosure mainly studies the case of controlling the duty ratio to be 0 to 0.5. At present, the conventional methods for changing the laser duty ratio include changing the defocusing amount to obtain different values of the duty ratio, the defocusing amount refers to the distance between the actual cladding forming plane and the plane where the optical focal point of the annular beam is located during laser cladding, but the change of defocusing amount will result in the change of laser energy density and the width (melting width) of the single pass cladding, which further affects the cladding forming quality.

### SUMMARY

An objective of the present disclosure is to provide a laser cladding apparatus having an adjustable duty ratio, which can adjust a laser duty ratio without changing defocusing amount, thus increasing the stability of cladding forming and improving the cladding forming quality.

In order to achieve the objective above, a laser cladding apparatus having an adjustable duty ratio is provided, the laser cladding apparatus includes a reflector holder, a parabolic focusing reflector, a fixed conical reflector, a movable conical reflector, and a powder nozzle. The fixed conical reflector and the parabolic focusing reflector are of annular structures, and reflecting surfaces of the movable conical reflector and the fixed conical reflector are arranged opposite to a reflecting focusing surface of the parabolic focusing reflector so as to reflect, in a circumferential direction, an incident beam in a central axis direction of the parabolic focusing reflector to the reflecting focusing surface to be reflected and focused by the reflecting focusing surface.

The reflector holder comprises a first annular fixing part arranged on an outer periphery thereof, a second annular fixing part arranged on an inner periphery thereof, and a rib plate connecting the first annular fixing part and the second annular fixing part; the parabolic focusing reflector is fixed on the first annular fixing part, and the fixed conical reflector is fixed on the second annular fixing part; the reflector holder further comprises a motion adjusting part penetrating through the second annular fixing part and configured to drive the movable conical reflector to move in the central axis direction of the parabolic focusing reflector, the movable conical reflector is fixed to a top end of the motion adjusting part, and the powder nozzle is fixed to a bottom end of the motion adjusting part.

Alternatively, the second annular fixing part comprises an annular body and an annular protrusion; the fixed conical reflector is sleeved on an outer periphery of the annular protrusion, and the annular protrusion is configured for clamping and limiting the movable conical reflector when the movable conical reflector moves away from the parabolic focusing reflector by a preset distance.

Alternatively, a limiting part is arranged at a preset length of a bottom end of the motion adjusting part, and the limiting part is configured for being clamped on a lower end surface of the second annular fixing part.

Alternatively, a diameter of the movable conical reflector is less than or equal to an inner diameter of the fixed conical reflector.

Alternatively, the motion adjusting part is a lifting bolt, the first annular fixing part and the rib plate are formed with a channel penetrating to the second annular fixing part, the channel has an adjusting bolt arranged therein, and the second annular fixing part is provided with a multi-stage bevel gear which makes the adjusting bolt and the lifting bolt in transmission connection.

Alternatively, each of the lifting bolt and the movable conical reflector is internally provided with a water-cooling space for absorbing accumulated heat in the movable conical reflector.

Alternatively, the parabolic focusing reflector is internally provided with a cooling channel.

Alternatively, the laser cladding apparatus further includes an apparatus housing, wherein the apparatus housing comprises a cavity shell which is matched with the reflector holder to enclose the parabolic focusing reflector.

Alternatively, the apparatus housing comprises a light entrance channel that is coaxial with and in communication with the cavity shell.

Alternatively, the laser cladding apparatus further includes a laser source connected to the light entrance channel.

According to a laser cladding apparatus having an adjustable duty ratio provided by the present disclosure, a laser source is used to irradiate a laser beam onto reflecting surfaces of the fixed conical reflector and the movable conical reflector arranged on the inner periphery of the parabolic focusing reflector. The laser beam, after reaching the reflecting surfaces of the fixed conical reflector and the movable conical reflector, is reflected to a reflecting focusing surface of the parabolic focusing reflector, and then reflected and focused by the reflecting focusing surface. A focal point generated by focusing is located at an outer side of a powder nozzle (the lower side in FIG. 1) to achieve powder feeding by the powder nozzle, thus conducting cladding forming on a working surface of a substrate.

A negative defocusing plane with a preset distance from one side of the focal point near the parabolic focusing reflector is taken as an exemplary cladding working plane to illustrate, when a laser duty ratio (a ratio of the non-beam area inside a laser spot to the overall area of the laser spot) needs to be adjusted, there is no need to change the distance between the laser cladding apparatus and the metal substrate, but only a need to adjust the movable conical reflector to move towards or away from the parabolic focusing reflector. At this time, an outer diameter of a spot formed by reflecting the reflected light of the fixed conical reflector by the reflecting focusing surface on the working plane remains unchanged, while the movement of the movable conical reflector causes an inner diameter of the spot formed by reflecting the reflected light of the movable conical reflector by the reflecting focusing surface on the working plane to change, such that the duty ratio of the laser spot can be adjusted without changing the defocusing amount of the working plane, the stability of cladding forming is increased, and the cladding forming quality is improved.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a schematic diagram of a laser cladding apparatus having an adjustable duty ratio according to an embodiment of the present disclosure;

FIG. 2 is a top view of a reflector holder in FIG. 1;

FIG. 3 is a schematic diagram of a change of duty ratios corresponding to different defocusing planes; and

FIG. 4 is a schematic diagram of a change of duty ratio of a laser cladding apparatus having an adjustable duty ratio according to an embodiment of the present disclosure at a set negative defocusing plane.

In the drawings:
1—apparatus housing; 2—movable conical reflector; 3—parabolic focusing reflector; 4—lifting bolt; 5—powder nozzle; 6—adjusting bolt; 7—reflector holder; 8—multi—stage bevel gear; 9—fixed conical reflector; 10—laser source;
11—cavity shell; 12—light entrance channel; 31—cooling channel;
71—first annular fixing part; 72—rib plate; and 73—second annular fixing part.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In order to make those skilled in the art understand the present disclosure better, the present disclosure is further described in detail below with reference to the accompanying drawings and the specific embodiments.

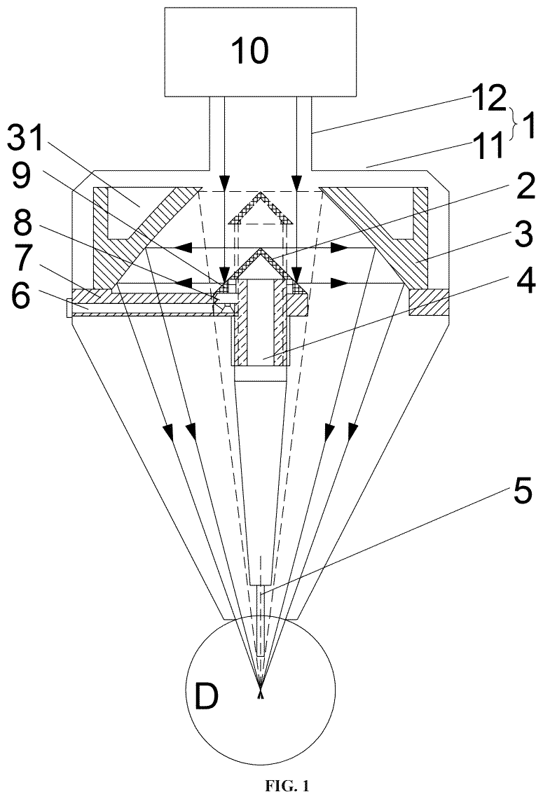

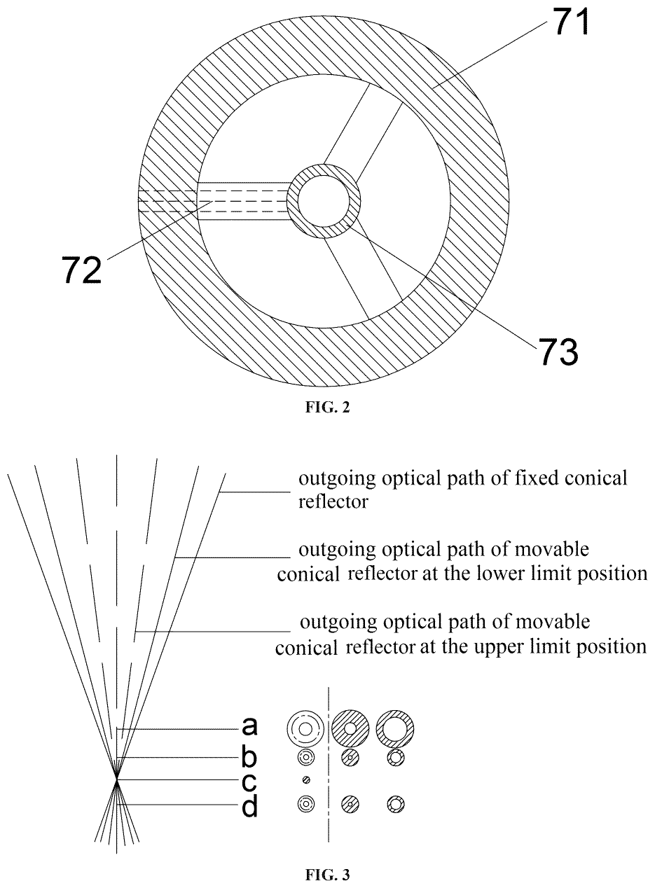

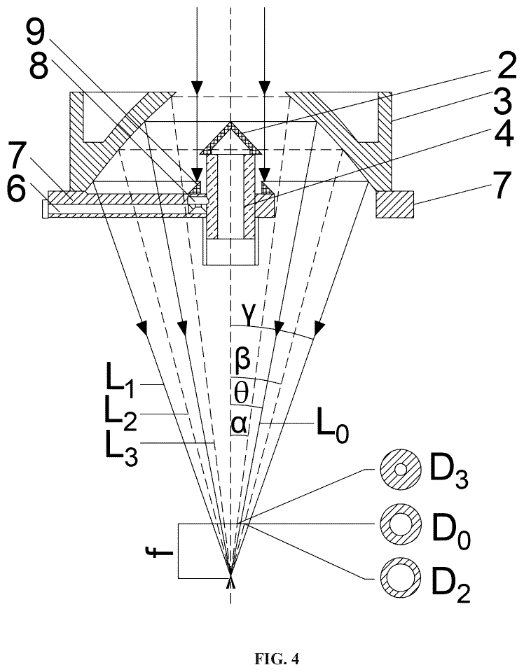

Please referring to FIG. 1 to FIG. 4, FIG. 1 is a schematic diagram of a laser cladding apparatus having an adjustable duty ratio according to an embodiment of the present disclosure; FIG. 2 is a top view of a reflector holder in FIG. 1; FIG. 3 is a schematic diagram of a change of duty ratios corresponding to different defocusing planes; and FIG. 4 is a schematic diagram of a change of duty ratio of a laser cladding apparatus having an adjustable duty ratio according to an embodiment of the present disclosure at a set negative defocusing plane.

A laser cladding apparatus having an adjustable duty ratio provided by an embodiment of the present disclosure, as shown in FIG. 1 and FIG. 2, includes a reflector holder 7, a parabolic focusing reflector 3, a fixed conical reflector 9, a movable conical reflector 2, and a powder nozzle 5. The parabolic focusing reflector 3 is fixed by a first annular fixing part 71 at the outer periphery of the reflector holder 7, and the fixed conical reflector 9 and the movable conical reflector 2 are arranged in the inner periphery of the parabolic focusing reflector 3, and reflecting surfaces of the fixed conical reflector 9 and the movable conical reflector 2 are arranged opposite to a reflecting focusing surface of the parabolic focusing reflector 3, so as to reflect, in a circumferential direction, an incident beam in a central axis direction of the parabolic focusing reflector 3 to the reflecting focusing surface to be reflected and focused by the reflecting focusing surface. The fixed conical reflector 9 is fixed by a second annular fixing part 73 at the inner periphery of the reflector holder 7, and the movable conical reflector 2 is driven by a motion adjusting part penetrating through the second annular fixing part 73 to reciprocate between the fixed conical reflector 9 and the parabolic focusing reflector 3. The powder nozzle 5 is fixed to a bottom end of the motion adjusting part. As such, when a metal substrate is placed at a certain negative defocusing plane distancing from one side of a focal point by a fixed distance, a light ring (outer diameter) generated by focusing a light beam reflected by the fixed conical reflector 9 remains unchanged, while a light ring (inner diameter) generated by focusing a light beam reflected by the movable conical reflector 2 changes with the movement of the movable conical reflector 2, thus adjusting a duty ratio of the laser spot without changing the defocusing amount.

Continuing to refer to FIG. 1 and FIG. 2, in an embodiment, the second annular fixing part 73 includes an annular body and an annular protrusion. The annular body is connected to the first annular fixing part 71 via a rib plate 72, and specifically, there may be three rib plates 72. The fixed conical reflector 9 is sleeved on the periphery of the annular protrusion, an axial dimension of the annular protrusion is greater than or equal to that of the fixed conical reflector 9, so as to limit a lower limit position of the movable conical reflector 2 by means of the annular protrusion.

In above embodiment, the motion adjusting part specifically is a lifting bolt 4. In this case, one rib plate 72 and the first annular fixing part 71 is formed with a channel penetrating to an outer side of the annular body, and an adjusting bolt 6 is arranged in the channel. A side part of the annular body is provided with a gap and is provided with a multi-stage bevel gear 8. The adjusting bolt 6 and the lifting bolt 4 are in transmission connection via the multi-stage bevel gear 8, and forward and reverse rotation of the adjusting bolt 6 is used to drive the multi-stage bevel gear 8 to rotate, so as to drive the lifting bolt 4 to drive the movable conical reflector 2 at a top end of the lifting bolt 4 to move. In the case that the motion adjusting part specifically is a lifting bolt 4, a limiting part protruding radially relative to the lifting bolt 4 may also be arranged at a preset length of a bottom end of the lifting bolt 4, the limiting part is configured for being clamped at a lower side of the annular body to limit an upper limit position of the movable conical reflector 2, and the limiting part may specifically be a bolt head of the lifting bolt 4. A diameter of a bottom end of the fixed conical reflector 9 is generally less than or equal to an inner diameter of the movable conical reflector 2.

It is conceivable that a driving mode of the motion adjusting part is not limited to the above embodiment, the motion adjusting part may also be a miniature electric push rod with its own lifting motion function, and the electric push rod may be controlled in a wired or wireless manner by forming a channel in the rib plate 72. The core of the present disclosure lies in keeping an outer diameter of a light ring at a negative defocusing plane at a set defocusing amount unchanged by means of the fixed conical reflector 9, and adjusting an inner diameter of the light ring by means of axial motion of the movable conical reflector 2 along the parabolic focusing reflector 3, so as to change the duty ratio.

In above embodiment, each of the lifting bolt 4 and the movable conical reflector 2 may be internally provided with a water-cooling space, and the parabolic focusing reflector 3 may be internally provided with a cooling channel 31, so as to cool the parabolic focusing reflector 3 and the movable conical reflector 2. An outer end surface of the adjusting bolt 6 may be provided with a rotary knob and marked with duty ratio data, so as to achieve quantized regulation. In addition, the laser cladding apparatus having an adjustable duty ratio further includes an apparatus housing 1. The apparatus housing 1 includes a cavity shell 11, and a light entrance channel 12 that is in coaxial with and in communication with the cavity shell 1. The cavity shell 11 is matched with the first annular fixing part 71 of the reflector holder 7 to enclose the parabolic focusing reflector 3, such that the light entrance channel 12, the cavity shell 11, the parabolic focusing reflector 3, the movable conical reflector 2 and the fixed conical reflector 9 are coaxially provided. The light entrance channel 12 is configured for a laser beam to enter and reach reflecting surfaces of the movable conical reflector 2 and the fixed conical reflector 9. Furthermore, the laser cladding apparatus having an adjustable duty ratio further includes a laser source 10 connected to the light entrance channel 12 and configured to irradiate a laser beam into the light entrance channel 12.

Referring to FIG. 1, the dotted movable conical reflector 2 and a dotted reflection optical path thereof are an upper movable limit position of the movable conical reflector 2 and an optical path thereof, and a height of the optical path corresponding to the upper limit position cannot be higher than a height of the top of the parabolic focusing reflector 3. The solid movable conical reflector 2 and a solid reflection optical path thereof are a lower movable limit position of the movable conical reflector 2 and an optical path thereof. Both optical paths keep a certain safe distance from the powder nozzle 5, so as to ensure that the optical path corresponding to the upper limit position cannot be reflected to the fixed conical reflector 9.

The outermost beam of an incident laser beam irradiates on the fixed conical reflector 9, and then passes through the parabolic focusing reflector 3 to obtain an outgoing optical path of the fixed conical reflector 9. The optical path is a fixed optical path in a case that a diameter of a circular beam of the incident laser beam is unchanged, and is unable to change with the movement of the movable conical reflector 2. A position of the top of the movable conical reflector 2 determines a diameter of an inner optical path.

Taking the change process of a laser duty ratio in a region D in FIG. 1 for illustration, as shown in FIG. 3, a plane c is a focal point plane of a annular laser, and an optical focal point of the parabolic focusing reflector 3 is located on the plane c. A plane d below the plane c is a positive defocusing plane, and planes a, b above the plane c are negative defocusing planes. The laser at the focal point converges to a point, with a duty ratio regarded as 1, and the value of the duty ratio cannot be changed by moving the movable conical reflector 2. When the working plane is located at the positive defocusing plane d, the duty ratio can be adjusted during high-speed cladding. The negative defocusing planes a, b are working planes for general laser cladding. In FIG. 3, sizes of solid spots on right sides respectively corresponding to places a, b are sizes of spots corresponding to the upper and lower limit positions of the movable conical reflector 2 respectively. By rotating the adjusting bolt 6 to drive the lifting bolt 4 and the movable conical reflector 2 to move up and down, the side of a spot can be changed between two limit sizes, finally achieving the change of the duty ratio within a certain range.

A position other than the upper and lower limit positions is selected to illustrate the present disclosure, and the whole apparatus is simplified at the same time. For the convenience of explanation, dotted lines are used to represent optical paths corresponding to two limit positions, as shown in FIG. 4, and the working plane with the defocusing amount of fis taken as an example to illustrate. When the adjusting bolt 6 is rotated to drive the lifting bolt 4 to move to a certain position, the movable conical reflector 2 is located at a position shown in FIG. 4.

In FIG. 4, the defocusing amount of the working plane is f, an actual outgoing optical path of the movable conical reflector 2 is L₀, an outgoing optical path of the fixed conical reflector 9 is L₁, an outgoing optical path of the movable conical reflector 2 at the lower limit position is L₂, an outgoing optical path of the movable conical reflector 2 at the upper limit position is L₃, a spot on the working plane corresponding to the actual outgoing optical path of the movable conical reflector is Do, a spot corresponding to the outgoing optical path of the movable conical reflector at the lower limit position is D₂, a spot corresponding to the outgoing optical path of the movable conical reflector at the upper limit position is D₃, an included angle between the outgoing optical path of the movable conical reflector 2 at the upper limit position and the central axis is a, an included angle between the outgoing optical path of the movable conical reflector 2 at the lower limit position and the central axis is 8, and an actual included angle between the actual outgoing optical path and the central axis is 0.

The actual outgoing optical path L₀ of the movable conical reflector 2 is located between the outgoing optical path L₂ of the movable conical reflector 2 at the lower limit position and the outgoing optical path L₃ of the movable conical reflector 2 at the upper limit position, which may be regarded as a general condition during laser cladding.

In this case, a desirable working spot on the plane with the defocusing amount of fis spot Do, with an inner diameter of d₁ and an outer diameter of d₂ respectively as follows:

$${d}_{1} = 2 \cdot f \cdot tan θ ; and$$

$${d}_{2} = 2 \cdot f \cdot tan γ .$$

The maximum spot on the working plane is the spot D₃ formed by the outgoing optical path L₃ of the movable conical reflector 2 at the upper limit position and the outgoing optical path L₁ of the fixed conical reflector 9, with an inner diameter of d₃ and an outer diameter of d₄ respectively as follows:

$${d}_{3} = 2 \cdot f \cdot tan α ; and$$

$${d}_{4} = 2 \cdot f \cdot tan γ .$$

The minimum spot on the working plane is the spot D₂ formed by the outgoing optical path L₂ of the movable conical reflector 2 at the lower limit position and the outgoing optical path L₁ of the fixed conical reflector 9, with an inner diameter of d₅ and an outer diameter of do respectively as follows:

$${d}_{5} = 2 \cdot f \cdot tan β ; and$$

$${d}_{6} = 2 \cdot f \cdot tan γ .$$

Thus, a value of the laser duty ratio n at the working plane is as follows:

$$η = \frac{\frac{1}{4} \cdot π \cdot [ {( {d}_{2} )}^{2} - {( {d}_{1} )}^{2} ]}{\frac{1}{4} \cdot π \cdot {( {d}_{2} )}^{2}}$$

with the change range as follows:

$$\frac{\frac{1}{4} \cdot π \cdot [ {( {d}_{6} )}^{2} - {( {d}_{5} )}^{2} ]}{\frac{1}{4} \cdot π \cdot {( {d}_{6} )}^{2}} \leq η \leq \frac{\frac{1}{4} \cdot π \cdot [ {( {d}_{4} )}^{2} - {( {d}_{3} )}^{2} ]}{\frac{1}{4} \cdot π \cdot {( {d}_{4} )}^{2}}$$

which can be simplified as follows:

$$\frac{[ {( tan γ )}^{2} - {( tan β )}^{2} ]}{{( tan γ )}^{2}} \leq η \leq \frac{[ {( tan γ )}^{2} - {( tan α )}^{2} ]}{{( tan γ )}^{2}}$$

The change range of θ is between α and β. According to the simplified formula, the laser duty ratio of the working plane (except the focal point plane) at any defocusing amount has the same change range, which is only related to the values of α, β and γ.

A commonly used data in experiments is brought into the formula of the change range of the laser duty ratio, wherein the data is as follows:

$$f = - 3 mm ; and γ = 19.3 ° .$$

The other parameters expected to reach are as follows:

$$α = 14.2 ° ; and β = 18.1 ° .$$

The change range of the laser duty ratio expected to reach is from 0.1278 to 0.4781, and thus the problem of poor stability in cladding forming process caused by excessive concentration of energy distribution can be well avoided.

The laser cladding apparatus having an adjustable duty ratio provided by the present disclosure can obtain different duty ratios by changing the inner diameter the laser beam irradiated on the surface of the substrate on the premise of not changing the outer diameter thereof, can achieve accurate and quantitative adjustment of the duty ratio by rotating the adjusting bolt 6 arranged outside, and has the following beneficial effects.
1. It is ensured that a melting width obtained by cladding is at a level with relatively small change amplitude without changing the outer diameter of the laser beam.
2. Different laser duty ratios can be obtained by only changing the inner diameter of the laser beam. In view of the laser cladding apparatus achieved by the present disclosure, the laser duty ratio can be added to study the cladding effect under different process parameters, so as to optimize the distribution of temperature field in the molten pool, and achieve the improvement of laser cladding forming quality.
3. The spot with required duty ratio can be conveniently obtained by means of quantified adjustment to a rotary knob.

It should be noted that in this specification, relational terms such as first and second are only used to distinguish one entity from several other entities, and do not necessarily require or imply the existence of any such actual relationship or order between these entities.

The laser cladding apparatus having an adjustable duty ratio provided by the present disclosure is introduced in detail above. Specific examples are used herein for illustration of the principles and implementation methods of the present disclosure. The description of the embodiments is merely used to help illustrate the method and its core principles of the present disclosure. It should be noted that a person of ordinary skill in the art can make various improvements and modifications on the present disclosure without departing from the principle of the present disclosure. Such improvements and modifications shall be regarded as falling into the scope of protection of the present disclosure.

1. A laser cladding apparatus having an adjustable duty ratio, comprising a reflector holder, a parabolic focusing reflector, a fixed conical reflector, a movable conical reflector, and a powder nozzle, wherein the fixed conical reflector and the parabolic focusing reflector are of annular structures, and reflecting surfaces of the movable conical reflector and the fixed conical reflector are arranged opposite to a reflecting focusing surface of the parabolic focusing reflector so as to reflect, in a circumferential direction, an incident beam in a central axis direction of the parabolic focusing reflector to the reflecting focusing surface to be reflected and focused by the reflecting focusing surface;
the reflector holder comprises a first annular fixing part arranged on an outer periphery thereof, a second annular fixing part arranged on an inner periphery thereof, and a rib plate connecting the first annular fixing part and the second annular fixing part; the parabolic focusing reflector is fixed on the first annular fixing part, and the fixed conical reflector is fixed on the second annular fixing part; the reflector holder further comprises a motion adjusting part penetrating through the second annular fixing part and configured to drive the movable conical reflector to move in the central axis direction of the parabolic focusing reflector, the movable conical reflector is fixed to a top end of the motion adjusting part, and the powder nozzle is fixed to a bottom end of the motion adjusting part.

2. The laser cladding apparatus having an adjustable duty ratio according to claim 1, wherein the second annular fixing part comprises an annular body and an annular protrusion;
the fixed conical reflector is sleeved on an outer periphery of the annular protrusion, and the annular protrusion is configured for clamping and limiting the movable conical reflector when the movable conical reflector moves away from the parabolic focusing reflector by a preset distance.

3. The laser cladding apparatus having an adjustable duty ratio according to claim 1, wherein a limiting part is arranged at a preset length of a bottom end of the motion adjusting part, and the limiting part is configured for being clamped on a lower end surface of the second annular fixing part.

4. The laser cladding apparatus having an adjustable duty ratio according to claim 1, wherein a diameter of the movable conical reflector is less than or equal to an inner diameter of the fixed conical reflector.

5. The laser cladding apparatus having an adjustable duty ratio according to claim 1, wherein the motion adjusting part is a lifting bolt, the first annular fixing part and the rib plate are formed with a channel penetrating to the second annular fixing part, the channel has an adjusting bolt arranged therein, and the second annular fixing part is provided with a multi-stage bevel gear which makes the adjusting bolt and the lifting bolt in transmission connection.

6. The laser cladding apparatus having an adjustable duty ratio according to claim 5, wherein each of the lifting bolt and the movable conical reflector is internally provided with a water-cooling space for absorbing accumulated heat in the movable conical reflector.

7. The laser cladding apparatus having an adjustable duty ratio according to claim 5, wherein the parabolic focusing reflector is internally provided with a cooling channel.

8. The laser cladding apparatus having an adjustable duty ratio according to claim 1, further comprising an apparatus housing, wherein the apparatus housing comprises a cavity shell which is matched with the reflector holder to enclose the parabolic focusing reflector.

9. The laser cladding apparatus having an adjustable duty ratio according to claim 8, wherein the apparatus housing comprises a light entrance channel that is coaxial with and in communication with the cavity shell.

10. The laser cladding apparatus having an adjustable duty ratio according to claim 9, further comprising a laser source connected to the light entrance channel.

11. The laser cladding apparatus having an adjustable duty ratio according to claim 5, wherein the second annular fixing part comprises an annular body and an annular protrusion; the fixed conical reflector is sleeved on an outer periphery of the annular protrusion, and the annular protrusion is configured for clamping and limiting the movable conical reflector when the movable conical reflector moves away from the parabolic focusing reflector by a preset distance.

12. The laser cladding apparatus having an adjustable duty ratio according to claim 5, wherein a limiting part is arranged at a preset length of a bottom end of the motion adjusting part, and the limiting part is configured for being clamped on a lower end surface of the second annular fixing part.

13. The laser cladding apparatus having an adjustable duty ratio according to claim 5, wherein a diameter of the movable conical reflector is less than or equal to an inner diameter of the fixed conical reflector.

14. The laser cladding apparatus having an adjustable duty ratio according to claim 8, wherein the second annular fixing part comprises an annular body and an annular protrusion; the fixed conical reflector is sleeved on an outer periphery of the annular protrusion, and the annular protrusion is configured for clamping and limiting the movable conical reflector when the movable conical reflector moves away from the parabolic focusing reflector by a preset distance.

15. The laser cladding apparatus having an adjustable duty ratio according to claim 8, wherein a limiting part is arranged at a preset length of a bottom end of the motion adjusting part, and the limiting part is configured for being clamped on a lower end surface of the second annular fixing part.

16. The laser cladding apparatus having an adjustable duty ratio according to claim 8, wherein a diameter of the movable conical reflector is less than or equal to an inner diameter of the fixed conical reflector.

17. The laser cladding apparatus having an adjustable duty ratio according to claim 11, wherein each of the lifting bolt and the movable conical reflector is internally provided with a water-cooling space for absorbing accumulated heat in the movable conical reflector.

18. The laser cladding apparatus having an adjustable duty ratio according to claim 12, wherein each of the lifting bolt and the movable conical reflector is internally provided with a water-cooling space for absorbing accumulated heat in the movable conical reflector.

19. The laser cladding apparatus having an adjustable duty ratio according to claim 13, wherein each of the lifting bolt and the movable conical reflector is internally provided with a water-cooling space for absorbing accumulated heat in the movable conical reflector.

20. The laser cladding apparatus having an adjustable duty ratio according to claim 11, wherein the parabolic focusing reflector is internally provided with a cooling channel.
